(19) United States
(12) Patent Application Publication
(10) Pub. No.: US 2014/0377509 A1
(43) Pub. Date: Dec. 25, 2014

(54) CORRUGATED PLASTIC BOARD

(71) Applicant: ALPHA MARATHON FILM EXTRUSION TECHNOLOGIES INC., Woodbridge (CA)

(72) Inventor: Michael A. Taylor, Orillia (CA)

(73) Assignee: Alpha Marathon Film Extrusion Technologies Inc.

(21) Appl. No.: 14/310,346

(22) Filed: Jun. 20, 2014

Related U.S. Application Data
(60) Provisional application No. 61/837,362, filed on Jun. 20, 2013.

(51) Int. Cl. B32B 3/28; B32B 27/08; B32B 7/02

(52) U.S. Cl. CPC B32B 3/28; B32B 7/02; B32B 27/08; B32B 2250/242; B32B 2250/40
USPC 428/182

(57) ABSTRACT

The present invention relates to plastic corrugated board. The board is made with a plurality of multi-layered sheets, each having three or more films all containing a common resin. The outer films are a blend of the common resin and one or more additional resins that soften the outer films relative to the core film, resulting in a soft/stiff/soft cross-sectional arrangement for each sheet.

### FIELD OF THE INVENTION

The present invention relates to corrugated plastic board and methods of manufacturing the same, using sheets having component film layers, to provide improved mechanical properties and functional characteristics to the corrugated plastic board.

### BACKGROUND OF THE INVENTION

In the prior art, corrugated plastic board material is typically manufactured from three “sandwiched” sheets made of the same plastic material. In cross section, the central sheet is corrugated, normally by thermoforming, and sandwiched between two outer sheets. The use of the same plastic material for each sheet limits the mechanical properties and functional characteristics of the corrugated plastic board material to those of the chosen plastic.

Different uses for corrugated plastic board material require different combinations of mechanical properties and functional characteristics. Consequently, there exists a need for a corrugated plastic board material with selectively variable mechanical properties and functional characteristics, such as, for example, stiffness, impact resistance, sealability, anti-slip protection, anti-microbial activity, and scrap inclusion.

### SUMMARY OF THE INVENTION

A corrugated plastic board made of a plurality of multi-layered sheets each made of at least three films. At least two of the films are outer films encapsulating one or more core films. The core films are made with a first resin having a first stiffness and the outer films are made with a blend of resins. The blend is a combination of the first resin and one or more additional resins which are compatible with the first resin. The blend of resins has a second stiffness that is less than said first stiffness.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a cross sectional view of a three layer sheet used to form a corrugated plastic board according to the present invention.

FIG. 2 is a cross sectional view of a corrugated plastic board according to the present invention, showing the interface between sheets and the corrugation of the middle sheet.

### DESCRIPTION OF THE INVENTION

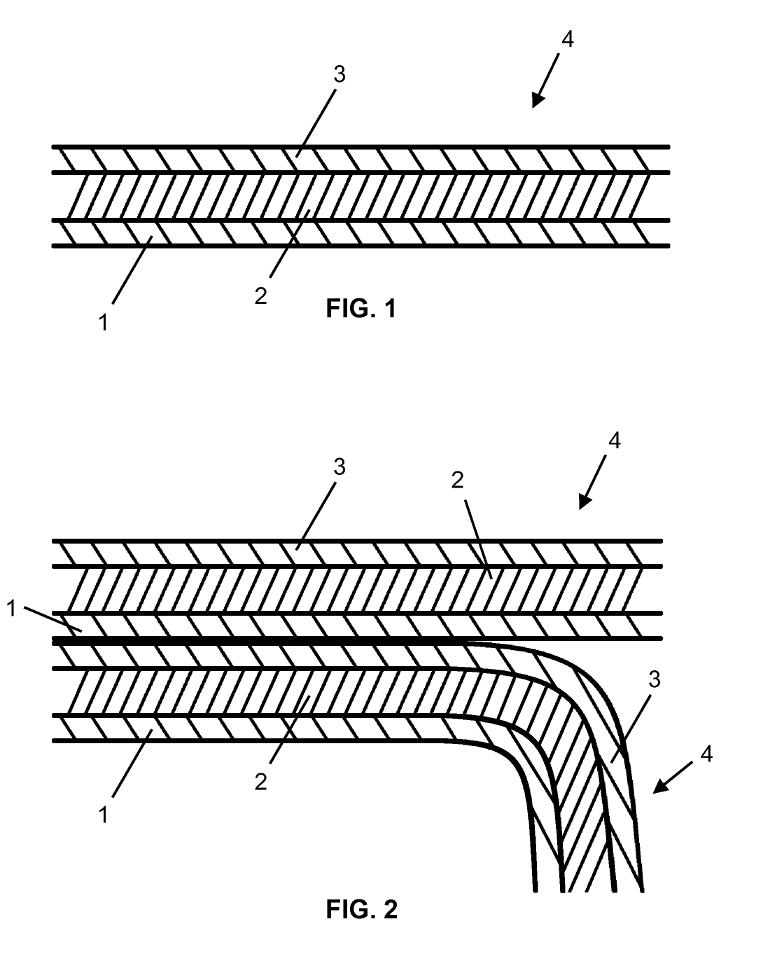

According to the present invention, a corrugated plastic board material is manufactured from two or more multi-layered sheets of plastic material. By way of example, FIG. 1 shows a preferred embodiment wherein each sheet is comprised of three films, namely: a base or outer film 1, a core film 2, and a top or outer film 3, which are joined together to form a sheet 4, as shown in FIG. 3.

Each outer film 1 and 3 shares a common resin material with the core film 2. The common resin is selected based on desirable mechanical properties, such as stiffness and rigidity. As the term is used in the present description, the stiffness of a material is characterized by its modulus of elasticity, which in a tensile test is the initial slope of the stress versus strain curve. The higher the modulus, the stiffer the material.

Examples of resin materials suitable for use as the common resin are high molecular weight high density polyethylene, homopolymer polypropylene, nylon, polyester, or polystyrene. The use of a common resin in each film inherently facilitates a three-film sheet structure having a high inter-boundary adhesion.

According to the present invention, the outer films 1 and 3 are modified and softened, with reference to the core film 2, by one of a number of polymers, which are compatible with the common resin, to create, in film cross-section, a stiffer core encapsulated by softer outer skins. The modification of the skins, or outer films 1 and 3, is meant to selectively introduce one or more desirable properties, for example, impact resistance, reduced sealing temperature, anti-slip protection, anti-microbial activity, or scrap inclusion. Film 1 may be modified independently of film 3 or the two films may be identical.

As the common resin is present in all films, and since the outer films are modified, by inclusion of a compatible polymer as a constituent in a blend with the common resin, the interboundary layers are completely miscible, achieving high interlayer adhesion between films and creating a soft/stiff/soft cross-section for the sheet. Because of this high interlayer adhesion and the elastic properties of the soft outer skins in combination with the stiff core, the corrugated plastic board is able to effectively disperse applied stresses from the force from an impact, to prevent damage to the board. Sheets containing more than three films and different film resins may be used.

The thickness of the films in each sheet can be selectively varied, thereby creating a stiffer or more flexible sheet depending on the relative thickness ratios of the films. For example, three sheets with a 20/60/20 thickness ratio result in a board, having a 20/60/20-20/60/20-20/60/20 cross-sectional arrangement. The adjacent sheets in the board are joined, preferably by heating the sheets to nearly the melting point of the skins and pressing them together. This joining process causes the adjacent skins to combine to form a single layer with double the thickness of each outer skin. In the example of sheets having a 20/60/20 thickness ratio, this results in a cross-sectional arrangement, in the three layer board, of 20/60/40/60/40/60/20. The stiffness may be increased by using sheets with a 10/80/10 thickness ratio, or reduced by using sheets with a 25/50/25 thickness ratio. Preferably, the sheets 4 are made using a thickness ratio of 25/50/25, which creates the desired stiffness for the board.

The stiffness of the corrugated board is increased by the so called “I” beam effect, in which alternating layers of films with differing stiffness result in a board with a stiffness higher than the cumulative average stiffness of the constituent materials. The “I” beam effect allows a corrugated board to be produced with the same stiffness and resilience, using less material, or, conversely, allows a corrugated board to be made with the same amount of material, but with greater stiffness.

According to the present invention, the corrugated plastic board has a soft/stiff/soft/soft/stiff/soft/soft/stiff/soft arrangement, when all three sheets are combined. By reason of this alternating arrangement, one imparts the benefits of the “I” beam effect to the board. As shown in FIGS. 1 and 2, the stiff core, or central film 2, is typically twice as thick as the soft outer skins, thereby maintaining the relative thickness ratio of the films.

To illustrate the “I” beam effect, reported testing of multiple films, consisting of repeating pair of equal thickness for a total of 25 layers of HDPE, Polypropylene, or Linear Low Density Polyethylene in tandem with Low Density Polyethylene, which acts as the soft resin, showed significant increase in secant modulus of elasticity, shown in the table below, which is a measurement of tensile distortion under load in air as opposed to pressure through a slot.

| | 1% Secant Modulus |
|---|---|
| | Machine Direction/Transverse |
| Resin Combination | Direction (psi) |
| HDPE/LDPE | 38,813/48,480 |
| PP/LDPE | 36,319/41,854 |
| LLDPE (octene polymer type)/LDPE | 26,730/30,429 |

The sheets 4 are preferably made using a compatibilizer to facilitate the formation of uniform blends of normally immiscible polymers, by reducing the interfacial energy between polymers in order to increase adhesion.

An example of a film layer material compatible with a homopolymer propylene common resin core to produce a highly impact resistant and impermeable corrugated plastic product is very low density polyethylene, such as, for example, DOW™ VLDPE DFDA-1095. It also offers improved pliability, anti-slip, and/or anti-microbial surface properties. An example of a film layer material compatible with a high molecular weight high density polyethylene common resin core to produce a highly impact resistant and impermeable corrugated plastic sheet material is a maleic anhydride modified copolymer or polypropylene copolymer, such as, for example, DOW™ Affinity™ EG 8200G.

Although the present invention has been described with reference to a three layer sheet example, multi-layered sheets with more than three films are contemplated, within the scope of the present invention. For example, the sheet 4, shown in FIG. 3, may be comprised of two or more soft outer films 1, two or more soft outer films 3, and two or more stiff core films 2. The core films 2 may be comprised of a blend of the common resin and another resin compatible with the common resin. Regardless of the number of films in the sheet 4, the soft-stiff-soft cross-sectional arrangement is maintained for each sheet 4.

In a further embodiment of the present invention the top surface and bottom surface of each film of the sheet 4 may be further modified by a number of polymer films that are compatible with the common resin core.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the disclosure.

What is claimed is:

1. A corrugated plastic board comprising a plurality of multi-layered sheets, wherein each sheet comprises at least three films, at least two of which are outer films encapsulating the remaining one or more films, which are core films, and wherein said core films comprise a first resin having a first stiffness and wherein said outer films comprise a blend of resins, said blend comprising said first resin and one or more additional resins which are compatible with said first resin, and said blend of resins having a second stiffness, wherein said second stiffness is less than said first stiffness.

2. The corrugated plastic board of claim 1, wherein said first resin is selected from the group of homopolymer polypropylene, high molecular weight high density polyethylene, nylon, polyester, or polystyrene.

3. The corrugated plastic board of claim 2, wherein said one or more additional resins are selected from the group of low-density polyethylene, very low-density polyethylene, linear low-density polyethylene, a maleic anhydride modified copolymer, or a polypropylene copolymer.

4. The corrugated plastic board of claim 1, wherein said first resin comprises homopolymer polypropylene and said one or more additional resins comprises very low density polyethylene.

5. The corrugated plastic board of claim 1, wherein said first resin comprises high molecular weight high-density polyethylene and said one or more additional resins comprises a maleic anhydride modified copolymer.

6. The corrugated plastic board of claim 1, wherein said first resin comprises high molecular weight high-density polyethylene and said one or more additional resins comprises a polypropylene copolymer.

7. The corrugated plastic board of claim 1, wherein one multi-layered sheet is corrugated.

8. The corrugated plastic board of claim 7, comprising three multi-layered sheets, wherein the middle multi-layered sheet is corrugated.

9. The corrugated plastic board of claim 1, wherein the one or more additional resins provide the outer films with one or more properties selected from the group of impact resistance, reduced sealing temperature, anti-slip protection, anti-microbial activity, or scrap inclusion.

10. A corrugated plastic board comprising a plurality of multi-layered sheets, wherein each sheet comprises at least three films, at least two of which are outer films encapsulating the remaining one or more films, which are core films, and wherein said core films comprise a first resin having a first stiffness, and wherein said outer films comprise a first blend of resins, said first blend comprising said first resin and one or more additional resins which are compatible with said first resin, and said first blend having a second stiffness, wherein said second stiffness is less than said first stiffness, and wherein one or more of said core films comprise a second blend of resins, said second blend comprising said first resin and one or more additional resins compatible with said first resin.
